(19) United States
(12) Patent Application Publication
(10) Pub. No.: US 2011/0011487 A1
(43) Pub. Date: Jan. 20, 2011

(54) APPARATUS AND METHODS FOR IMPROVED WINE BOTTLE POURING

(76) Inventor: Coy Lee Barnes, Paso Robles, CA (US)

Correspondence Address: Coy Barnes, 1607 Via Rosa, Paso Robles, CA, 93446, US

(21) Appl. No.: 12/424,460

(22) Filed: Apr. 15, 2009

(51) Int. Cl. B67D 7/00; B65D 23/06

(52) U.S. Cl. 141/1; 215/392

(57) ABSTRACT

The apparatus and methods of the present invention in a broad aspect provide enhanced safety wine glass pouring fulcrums in a resilient collar that frictionally engages the neck of a wine bottle in a non-rotational relationship below the bottle outlet to position the outer frictional surface of the collar where it will radially compress to form a stable pivot point for the wine bottle when pressed against the edge of a wine glass. The outer surface of the collar can be hydrophobic or hydrophilic and may be smooth or porous.

### FIELD OF THE INVENTION

The present disclosure generally relates to apparatus and associated methods for enhancing the safety, control, and cleanliness of the process of pouring wine from a wine bottle into a wine glass or other container. More particularly, the present invention is particularly well suited to securely and accurately hand pouring multiple glasses of wine from a single bottle into a wide variety of containers without fear of chipping their delicate edges or of spills, drips or stains.

### BACKGROUND OF THE INVENTION

With the ever increasing popularity of wine and other bottled spirits in contemporary culture and social life has come a developing need to facilitate the distribution and sharing of wine and bottled spirits with multiple guests and friends in a convenient and safe manner. The simple act of pouring a liquid from a bottle into one or more glasses can become a complicated, awkward, and messy operation involving potential breakage and spillage when the relative positioning of the bottle outlet to the glass mouth is unstable or highly variable. This is particularly true in social situations where people are moving and hand held glasses are being filled and refilled.

In the past, professional wine stewards with stable hands were relied upon to gently open and decant wine bottles in order to avoid disturbing sediments, spilling wine, and chipping glasses as the bottle contents were shared and consumed. This was a particular issue where fragile blown glass and cut crystal glasses were used as their edges could be chipped or damaged by inappropriately abrupt or unexpectedly harsh contact between the glass neck of a wine bottle and the edge of glass. Thus, properly pouring wine from a bottle traditionally has been more of an art than a casual endeavor for the uninitiated.

Recently, a number of devices and techniques have been developed and implemented in an effort to improve the outcome of the process of pouring wine and other liquids from bottles, primarily by absorbing spills. These range from simply tying a folded cloth napkin around the bottle neck to absorb drips and spills to designer metal rings having absorbent inner liners that are slipped around the bottle neck for similar purposes. Alternative devices include a variety of paper blotter based rings and collars, some including fringes and teeth designed to increase surface area for drop retention, which are glued to bottle necks or secured with retaining devices. Even more recently complicated multi-layered “drip-proof” shells that are shrink fit or adhered to bottle necks have been proposed that include inner absorbent layers to prevent drips and stains.

For example, one such device is marketed as the “Drip Dickey®” by the Drip Dickey Corporation and is constructed of a stretchable tube formed of a designer knit fabric material that is slipped over and adhered to the circumference of a bottle neck so that it is flush with the top of the bottle. It functions to prevent wine stains by absorbing stray drops, apparently through capillary adhesion between the fibers of the knit as well as within the open gap formed between the relatively loose fitting tube and the top of the wine bottle neck. The “Drip Dickey®” is advertised as being able to protect the edge of glasses, apparently by preventing direct contact between the glass edge and the glass bottle neck.

While reasonably effective at preventing minor drips and stains that can result from pouring, the stretchable loose fabric of this device actually complicates the pouring process by interfering with the tactile feel and feedback of the pour due to the vague and difficult to control longitudinal and rotational motion of the stretchy knit fabric relative to the glass edge and the bottle neck. Additionally, the “Drip Dickey®” can actually release excess wine drops that are retained in the gap formed by the top of the bottle neck and the top of the “Drip Dickey®” when the bottle is tipped beyond horizontal, further complicating the pouring process and its desired outcome or a clean pour.

Similarly, while the prior art decorative metal rings with absorbent liners are effective at preventing drips while the bottles they are mounted upon remain in a vertical orientation, when the bottles are tipped to a near horizontal position or beyond for pouring the rings can slide toward the bottle outlet and can even fall completely off the bottle neck. This unexpected and surprising, result can significantly complicate the pouring process by distracting the steward or host conducting the pour at the worst possible moment.

As a result, there is an ongoing need in the art for apparatus and methods that will enhance the functionality of wine bottles and the like, as well as the outcome of transferring the contents of glass bottles to fragile glasses and containers in dynamic social situations.

### SUMMARY OF THE INVENTION

These and other objects are achieved by the apparatus and methods of the present disclosure which, in a broad aspect, provide self-stabilizing, self-adjusting, repeatably self-forming pouring fulcrums for wine bottles and the like that effectively maintain the intended positioning of the bottle neck and outlet relative to the mouth of the intended receptacle or glass. In a broad aspect the self-stabilizing wine glass pouring fulcrums of the present invention include a generally cylindrical collar having an upper end and a lower end and an inner surface extending between the upper and lower ends. The interior bore of the cylindrical collar is dimensioned to frictionally engage the neck of a wine bottle in a secure, non-rotational relationship at a position spaced below the outlet of the bottle. The collar includes an outer frictional surface that extends between the upper and lower ends and is spaced apart from the inner surface engaging the neck of the bottle. This outer frictional surface is radially compressible toward the inner surface when pressed against a hard object like the edge of a glass. In this manner, the apparatus of the present invention is able to form a stable pivot point atop the edge of the glass which functions to maintain the positioning of the bottle neck relative to the mouth of the glass. Moreover, as those skilled in the art will appreciate, the stable pivot point of the present invention is self-adjusting and will adapt to the diameter and thickness of the glass edge as the bottle is levered over the fulcrum without sliding or slipping; thereby providing a stable and consistent tactile feel to the pour that dampens the normally present glass-upon-glass feedback of convention pours while maintaining the intended relative position of the bottle neck to the glass mouth.

Of equal importance, the outer frictional surface of the present invention is circumferentially stable relative to the neck of the bottle so that if the bottle is rotated about its axis during the pour the self-stabilizing pivot point of the fulcrum will adjust and reform as necessary to maintain a stable and consistent fulcrum during the pour without putting undue pressure on the fragile edge of the glass and without sliding or slipping. In this manner, the self-stabilizing wine glass pouring fulcrum of the present invention maintains the relative orientation of the wine bottle neck and outlet to the mouth of the glass even during complex motions of the bottle neck in three dimensions relative to the wine glass.

Further, the generally cylindrical collar of the present invention can be produced in a variety of dimensions ranging from a majority of the length of the wine bottle neck to half the neck length or less. This makes it possible to position the outlet of a bottle equipped with the present invention at or near the center of the mouth of a target glass regardless of the diameter of the glass mouth without sacrificing the ability of the present invention to provide a self-stabilizing wine glass pouring fulcrum.

Similarly, the thickness of the generally cylindrical collar can be produced in a variety of dimensions ranging from about one to ten millimeters or more, regardless of the axial length of the collar. In accordance with the teachings of the present disclosure, as long as the collar is produced with sufficient thickness to space the outer frictional surface apart from the inner surface engaging the neck of the bottle the outer frictional surface will be radially compressible toward the inner surface when pressed against a hard object like the edge of a glass in order to form the self-stabilizing, self-adjusting fulcrum.

In further accordance with the teachings of the present disclosure, the outer frictional surface can be either hydrophobic or hydrophilic and can be porous or smooth. As those skilled in the art will appreciate, smooth hydrophobic outer frictional surfaces are easy to clean whereas hydrophilic or porous outer frictional surfaces provide the added benefit of adsorbing drips and minor spills; thereby reducing or preventing stains on linens and tables. In any of these alternative embodiments, the outer frictional surface can be embossed or printed with decorative colors, designs, indicia, or text without detracting from the functional operability of the present invention.

Exemplary compositions and materials for producing the self-stabilizing wine glass pouring fulcrums of the present invention include, without limitation natural and synthetic rubber foams, expanded polymer foams, cellulosic foams, and the like. Depending upon the materials used, the self-stabilizing wine glass pouring fulcrums can be produced through a wide variety of currently known techniques including, without limitation, casting, cutting, punching, dipping, spraying, and the like. As those skilled in the art will appreciate, the self-stabilizing wine glass pouring fulcrums can be mounted on the neck of a bottle before, during, or after the bottle filling process. Accordingly, the self-stabilizing wine glass pouring fulcrums can be sold separately to consumers for later use and reuse, or can be produced and marketed in conjunction with the original bottles.

Utilizing the teachings of the present disclosure an enhanced safety method for pouring liquids such as wine from a wine bottle into a glass is provided that not only improves the control of the process, but also enhances the outcome of the process by removing potentially damaging distractions. This is accomplished through the steps of providing the neck of a bottle such as a wine bottle with a self-stabilizing wine glass pouring fulcrum as detailed above and then lightly pressing the outer frictional surface of the self-stabilizing wine glass pouring fulcrum down onto the edge of a glass. This action compresses the outer frictional surface against the top of the glass edge causing it to adapt to the contours of the glass edge and to form a stable, self-adjusting, self-damping pivot point for the bottle neck at a stable position relative to the glass edge.

By raising the base of the bottle or, in effect, tipping the bottle about the pivot point so formed an operator is able to decant a desired amount of the contents of the bottle into the glass without putting undue pressure or stress on the fragile edge of the glass. Once this is accomplished, simply removing the outer frictional surface from the edge of the glass causes the self-adjusting fulcrum to return to the original generally cylindrical conformation of the outer frictional surface in preparation for fulcrum forming contact and adjustment with the next glass.

As those skilled in the art will appreciate, where the self-stabilizing wine glass pouring fulcrums of the present disclosure are provided with porous or hydrophilic outer frictional surfaces the last step in the enhanced safety pouring process includes adsorbing any wine drips or minor spills onto the outer frictional surface prior to or after removing the fulcrum form the edge of the glass.

Further advantages and features of the self-stabilizing wine glass pouring fulcrums of the present disclosure will be provided to those of ordinary skill in the art from a consideration of the following Detailed Description of the Invention taken in conjunction with the accompanying drawings, which first will be described briefly.

### BRIEF DESCRIPTION OF THE DRAWINGS

FIG. 1 is a partial plan view of an exemplary embodiment of the present invention positioned upon the neck of a bottle.

FIG. 2 is a cross-sectional view of the exemplary embodiment of the present invention illustrated in FIG. 1 taken along the plane A-A.

FIG. 3 is a cross-sectional view of an exemplary embodiment of the present invention similar to that of FIG. 2 in use on the edge of a glass and illustrating additional features of the present invention.

### DETAILED DESCRIPTION OF THE INVENTION

The present disclosure generally is related to apparatus and methods which provide repeatable self-stabilizing, self-adjusting, self-forming pouring fulcrums for safely and conveniently dispensing liquids such as wine from bottles having extending necks. The present invention accomplishes these results effectively maintaining the intended positioning of the bottle neck and its outlet relative to the mouth of the intended receptacle or glass during the pouring process.

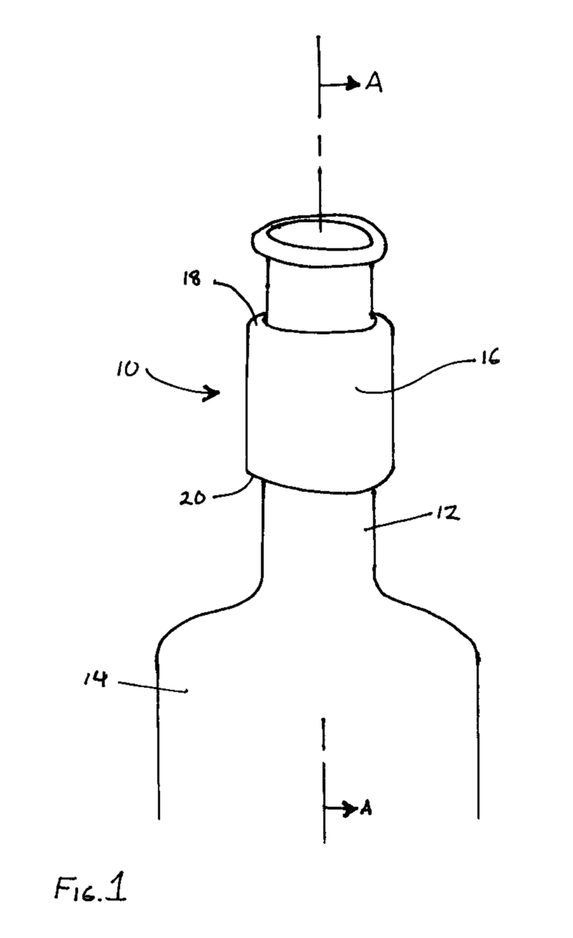

Turning now to FIG. 1, an exemplary embodiment of the self-stabilizing wine glass pouring fulcrums of the present invention is generally indicated by reference 10 and is shown mounted upon the extending neck 12 of bottle 14. Self-stabilizing wine glass pouring fulcrum 10 includes a generally cylindrical collar 16 having an upper end 18 and a lower end 20. Both upper end 18 and lower end 20 are illustrated as being non-crenulated and smooth, in direct contrast to the high surface area toothed edges of the prior art; which can retain and transfer unwanted drips. However, it is within the scope of the present invention to have additional edge details beyond smooth upper and lower ends 18 and 20, respectively.

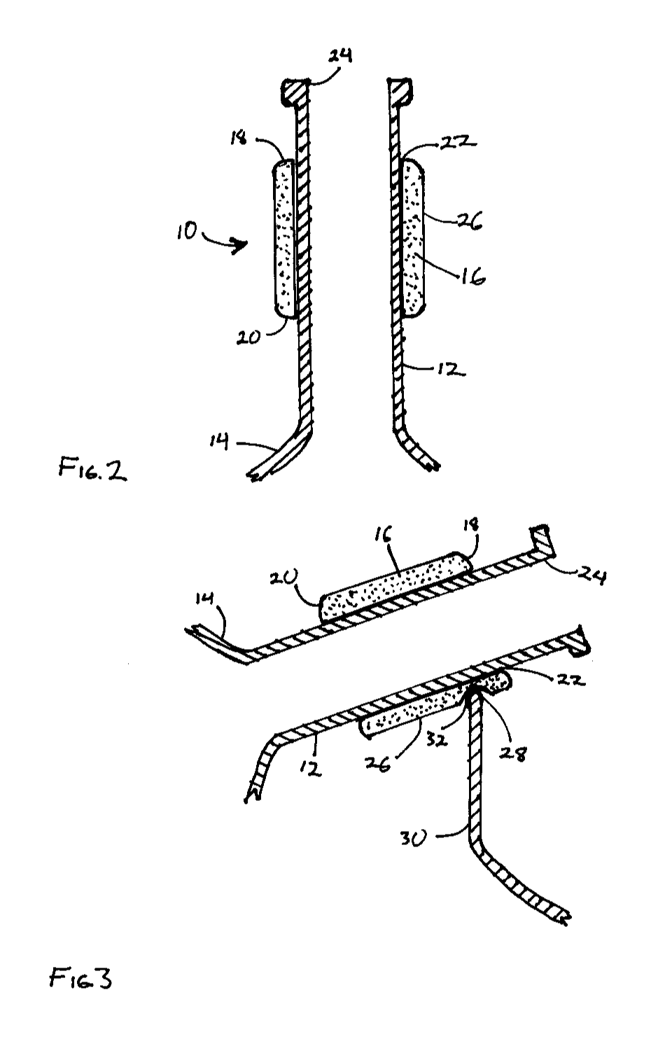

As further illustrated in FIG. 2, inner surface 22 of cylindrical collar 16 extends between upper end 18 and lower end 20 and is dimensioned to frictionally engage the extending neck 12 of bottle 14 in a secure, non-rotational relationship relative to extending neck 12. Though not essential to the practice of the present invention, cylindrical collar 16 is shown at a position spaced below the outlet 24 of extending neck 12 of bottle 14. This position provides the added benefit of eliminating any potential fluid retaining gaps that may be formed between upper end 18 and outlet 24 and is in direct contrast to the teachings of the prior art.

Cylindrical collar 16 includes an outer frictional surface 26 that extends between upper end 18 and lower end 20 and is spaced apart from inner surface 22 engaging extending neck 12 of bottle 14. Outer frictional surface 26 is radially compressible toward inner surface 22 when pressed against a hard object like edge 28 of glass 30 as shown in FIG. 3. Thus, by deforming to match the three-dimensional contours of edge 28 and by frictionally engaging these contours with a larger surface area that is resiliently pressed against this three-dimensional configuration of edge 28 the self-stabilizing wine glass pouring fulcrums of the present invention reliably and consistently form a stable pivot point 32 atop the edge of each glass 30 which functions to provide confident and controllable feedback while maintain the position of extending neck 12 relative to the mouth of glass 30 during the pouring process.

It should be emphasized that the stable pivot point 32 of the present invention is self-adjusting and will adapt to the diameter and thickness of edge 28 of glass 30 without moving relative to edge 28 or moving relative to extending neck 12 of bottle 14 as extending neck 12 is levered over the pouring fulcrum formed by stable pivot point 32. Thus, once engaged with edge 28, self-stabilizing wine glass pouring fulcrum 10 effectively prevents unintended sliding, slipping, or rotating of extending neck 12 relative to edge 28. As those skilled in the art will appreciate, because outer frictional surface 26 is self-adjusting in its ability to radially compress toward inner surface 22 it also provides a stable and consistent tactile feel to the pouring process. This tactile feedback includes a consistent, soft frictional engagement with edge 28 of glass 30 that also damps the harsh and potentially damaging glass-upon-glass grinding normally present during conventional prior art pours while maintaining the intended relative position of extending neck 12 to the mouth of glass 30.

Where adjustment or repositioning of extending neck 12 relative to edge 28 of glass 30 is desired, the apparatus operator simply lifts cylindrical collar 16 out of engagement with edge 28 which immediately results in outer frictional surface 26 expanding away from inner surface 22 of cylindrical collar 16 substantially eliminating stable pivot point 32. Once the operator repositions extending neck 12 as desired, cylindrical collar 16 is pressed against edge 28 in its new relative orientation and a new stable pivot point 32 is formed to assist in the retention of this new relative orientation.

Further adding to the functional stability of the pouring fulcrum of the present invention, outer frictional surface 26 of cylindrical collar 16 is circumferentially stable relative to extending neck 12 of bottle 14 so that if bottle 14 is rotated about its axis during the pour stable pivot point 32 of the self-stabilizing wine glass pouring fulcrum will adjust and reform automatically and virtually instantaneously. In this manner the present invention maintains a stable and consistent fulcrum during the pour without putting undue pressure on the fragile edge 28 of glass 30 even during complex relative motions in three dimensions between extending neck 12 of bottle 14 and edge 28 or glass 30.

Cylindrical collar 16 can be constructed or produced in a wide range of thicknesses, diameters, and lengths as determined by those of ordinary skill in the art to be appropriate for the dimensions of the intended bottle neck upon which cylindrical collar 16 is to be mounted. As shown in FIG. 1, exemplary lengths for cylindrical collar 16 include lengths covering a majority of the length of extending neck 12. As those skilled in the art will also appreciate, shorter lengths of half the length of extending neck 12, or less, are also within the scope of the present invention. Exemplary non-limiting lengths for cylindrical collar 16 range from about ten millimeters to about 30 millimeters.

Similarly, the thickness of cylindrical collar 16 can be produced in a variety of dimensions ranging from about one to about ten millimeters or more, regardless of the axial length or internal extending neck engaging bore diameter of cylindrical collar 16. As those skilled in the art will appreciate, as long as cylindrical collar 16 is formed of a compressible or resilient material with sufficient thickness to space outer frictional surface 26 apart from inner surface 22 engaging extending neck 12 of bottle 14, outer frictional surface 26 will be radially compressible toward inner surface 22 when pressed against a hard object like edge 28 of glass 30 to form stable pivot point 32 of the self-stabilizing wine glass pouring fulcrum of the present invention.

Exemplary radially compressible materials for producing the self-stabilizing wine glass pouring fulcrums of the present invention include, without limitation natural and synthetic rubber foams, expanded polymer foams, cellulosic foams, and the like. Additionally, it is within the scope and teachings of the present invention to form the self-stabilizing wine glass pouring fulcrums of the present invention from open and closed cell foams and composite materials including such foams and additional fibers, layers, and the like. However, as those skilled in the art will appreciate, expanded foams are inexpensive to obtain and to manufacture, adding to the desirability of the present invention.

Depending upon the materials and compositions used to form the self-stabilizing wine glass pouring fulcrums of the present invention, those skilled in the art can produce the apparatus through a wide variety of currently known techniques including, without limitation, casting, cutting, punching, rolling, dipping, spraying, and the like. As those skilled in the art also will appreciate, the self-stabilizing wine glass pouring fulcrums of the present invention can be formed directly on the neck of a bottle before, during, or after the bottle filling process or can be mounted on the neck or a bottle by a subsequent user immediately prior to initiating a pour.

In further accordance with the teachings of the present disclosure, outer frictional surface 26 can be made to be either hydrophobic or hydrophilic and also can be porous or smooth. As those skilled in the art will appreciate, this can be accomplished through a simple choice of manufacturing materials or coatings and can even include decorative printing or design elements. Smooth or hydrophobic outer frictional surfaces are both attractive and easy to clean. In contrast, an added benefit of forming cylindrical collar 16 with a hydrophilic or porous outer frictional surface is the capacity of such surfaces to adsorb drips and minor spills that may cling to the edges of outlet 24 pf bottle 14. This alternative embodiment of the present invention is thereby able to reduce or even prevent stains on linens and table surfaces. As noted above, in any of these alternative embodiments, outer frictional surface 26 can be embossed or printed with decorative colors, designs, indicia, or text without detracting from the functional operability of the present invention.

Utilizing the teachings of the present disclosure enhanced safety and improved control methods for pouring liquids such as wine from a wine bottle into a glass are provided that not only improve the control of such processes, but also enhance the outcome of these processes by removing potentially damaging distractions and by virtually eliminating breakage, spills, and stains. An exemplary method in accordance with the teachings of the present invention includes the steps of providing the neck of a bottle such as extending neck 12 of bottle 14 with a self-stabilizing wine glass pouring fulcrum of the present invention as detailed above and then lightly pressing the outer frictional surface 26 cylindrical collar 16 of the self-stabilizing wine glass pouring fulcrum down onto the edge 28 of a glass such as glass 30. This pressing action compresses outer frictional surface 26 against the top edge 28 of glass 30 causing outer frictional surface 26 to adapt to the contours of edge 28 and to form a stable, self-adjusting, self-damping pivot point 32 for the extending neck 12 of bottle 14 at the position of choice relative to the edge 28 of glass 30.

Then, by raising the base (not shown) of bottle 14 or, in effect, tipping bottle 14 about stable pivot point 32 so formed an operator is able to decant a desired amount of the contents of bottle 14 (not shown) into glass 30 without putting undue pressure or stress on the fragile edge 28 of glass 30. Once this is accomplished, simply removing outer frictional surface 26 from edge 28 of glass 30 or bottle 14 causes the self-adjusting fulcrum formed by stable pivot point 32 to return to the original generally cylindrical configuration of outer frictional surface 26 of cylindrical collar 16 in preparation for fulcrum forming contact and adjustment with the next glass.

As those skilled in the art will appreciate, where the self-stabilizing wine glass pouring fulcrums of the present disclosure are provided with porous or hydrophilic outer frictional surface 26 the last step in the enhanced safety pouring process of the present invention includes adsorbing any wine drips or minor spills onto the outer frictional surface prior to or after removing stable pivot point 32 from edge 28 of glass 30.

Though the apparatus and methods of the present invention have been discussed in the exemplary non-limiting context of pouring wine from wine bottles into glasses, it should be emphasized that the present invention is directly applicable to pouring liquids other than wine into containers other than glasses. Additionally, it is also contemplated as being within the scope of the present invention to utilize the self-stabilizing wine glass pouring fulcrums of the present invention with a wide variety of bottles and bottle closures including corks, screw caps, and single use closures.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A self-stabilizing wine glass pouring fulcrum comprising:
a generally cylindrical collar having an upper end and a lower end,
an inner surface extending between said upper end and said lower end of said collar and dimensioned to frictionally engage the neck of a wine bottle in a secure, non-rotational relationship at a position disposed below the outlet of said wine bottle; and
an outer frictional surface extending between said upper end and said lower end of said collar, said outer surface spaced apart from and radially compressible toward said inner surface.

2. The self-stabilizing wine glass pouring fulcrum of claim 1, wherein said outer frictional surface is circumferentially stable.

3. The self-stabilizing wine glass pouring fulcrum of claim 1, wherein said collar extends for a majority of the length of said neck of said wine bottle.

4. The self-stabilizing wine glass pouring fulcrum of claim 1, wherein said collar extends for half or less of the length of said neck of said wine bottle.

5. The self-stabilizing wine glass pouring fulcrum of claim 1, wherein said outer frictional surface is hydrophobic.

6. The self-stabilizing wine glass pouring fulcrum of claim 1, wherein said outer frictional surface is hydrophilic.

7. The self-stabilizing wine glass pouring fulcrum of claim 1, wherein said outer frictional surface is porous.

8. The self-stabilizing wine glass pouring fulcrum of claim 1, wherein said outer frictional surface is smooth.

9. The self-stabilizing wine glass pouring fulcrum of claim 1, wherein said collar is formed of resilient foam.

10. The self-stabilizing wine glass pouring fulcrum of claim 9, wherein said resilient foam is selected from the group consisting of natural rubber foams, synthetic rubber foams, expanded polymer foams, and cellulosic foams.

11. A self-stabilizing wine glass pouring fulcrum comprising:
a generally cylindrical collar having an upper end and a lower end,
an inner surface extending between said upper end and said lower end of said collar and dimensioned to frictionally engage the neck of a wine bottle instead there through in a longitudinally secure, non-rotational relationship at a position where said upper end is disposed below the outlet of said wine bottle neck; and
a circumferentially stable outer frictional surface extending between said upper end and said lower end of said collar, said outer surface spaced apart from and radially compressible toward said inner surface.

12. The self-stabilizing wine glass pouring fulcrum of claim 11, wherein said collar extends for a majority of the length of said neck of said wine bottle.

13. The self-stabilizing wine glass pouring fulcrum of claim 11, wherein said collar extends for half or less of the length of said neck of said wine bottle.

14. The self-stabilizing wine glass pouring fulcrum of claim 11, wherein said outer frictional surface is hydrophobic.

14. The self-stabilizing wine glass pouring fulcrum of claim 11, wherein said outer frictional surface is hydrophilic.

15. The self-stabilizing wine glass pouring fulcrum of claim 11, wherein said outer frictional surface is porous.

16. The self-stabilizing wine glass pouring fulcrum of claim 11, wherein said outer frictional surface is smooth.

17. The self-stabilizing wine glass pouring fulcrum of claim 11, wherein said collar is formed of resilient foam.

18. The self-stabilizing wine glass pouring fulcrum of claim 17, wherein said resilient foam is selected from the group consisting of expanded polyolefin and.

19. An enhanced safety method for pouring wine from a wine bottle into a glass, said method comprising the steps of:
providing the neck of said wine bottle with the self-stabilizing wine glass pouring fulcrum of claim 1;
lightly pressing the outer frictional surface of said self-stabilizing wine glass pouring fulcrum down onto the edge of said glass to radially compress said outer frictional surface and form a stable pivot point in said self-stabilizing wine glass pouring fulcrum atop said edge of said glass;
tipping said wine bottle about said stable pivot point to decant wine from said wine bottle into said glass; and
removing said outer frictional surface of said self-stabilizing wine glass pouring fulcrum from the edge of said glass.

20. The enhanced safety method for pouring wine from a wine bottle into a glass of claim 19 further comprising the additional step of adsorbing any wine drips onto said outer surface after said removing step.
